(19) United States
(12) Patent Application Publication
(10) Pub. No.: US 2013/0282858 A1
(43) Pub. Date: Oct. 24, 2013

(54) INTERNET ON-LINE SCHOOL OLD INFORMATION RETRIEVAL SYSTEM

(71) Applicant: Mel Francis P. QUINTOS, III, Fairfax Station, VA (US)

(72) Inventor: Mel Francis P. QUINTOS, III, Fairfax Station, VA (US)

(21) Appl. No.: 13/451,797

(22) Filed: Apr. 20, 2012

(51) Int. Cl. G06F 15/16

(52) U.S. Cl. 709/217

(57) ABSTRACT

An on-line system for retrieving old school information in assisting students with their school courses. The invention is a system whereby a student goes to the interact and requests assistance by retrieving old information about a course he/she wishes to take or is currently taking. Such old information may include old notes, old homework problems and/or corresponding solutions, old lecture slides, old examinations, etc. In addition, the student can find information on the professor, teacher or teaching assistant who teaches the school course of interest. Further, after having taken the course, the student may similarly upload any old information of interest pertaining to the course, and may similarly rate the professor, teacher or teaching assistant.

### BACKGROUND OF THE INVENTION

1. Field of the Invention

This invention generally relates to an on-line system for retrieving old school information in assisting students with their school courses. More particularly, this invention is directed to a system whereby a student goes to the internet and requests assistance by retrieving old information about a course he/she wishes to take or is currently taking. Such old information may include old notes, old homework problems and/or corresponding solutions, old lecture slides, old examinations, or the like. In addition, the student can find information on the professor, teacher or teaching assistant who teaches the school course of interest. Further, the student may upload any old information of interest pertaining to the school course of interest.

### SUMMARY OF THE INVENTION

When a student intends to take a course or is taking a course, it is to the benefit of the student to do the course homework, attend all lectures, take lecture notes, study the lecture slides, study the book or the like. At times however, despite the students' efforts in his or her attempt to attain a high grade for the course, all the students' efforts in studying may become futile when the professor or teacher does not, for example, base the exam materials from the above-mentioned materials studied by the student. This occurs when, for example, the teacher or professor obtains the examination materials from an internet examination bank for expediency in preparing the examination or in correcting the examination. A multiple choice examination, for example, may be attained by the professor or teacher from the internet, whereby the examination can be readily corrected with the use of a readily available answer sheet for the examination obtained from the internet. Also, for example, if the professor or teacher relies on another professor or teacher from a different section of the course to prepare the examination, the student of the former professor or teacher is not privy to the later professor's or teacher's lectures.

This invention can assist a student by allowing the student to get in the internet to determine any information on the course he or she intends to take or is taking, and to obtain any information on the professor or teacher (or teaching assistant) of the course. The student inputs the course information, and may review the information or rating of the professor, teacher or teaching assistant. The student may request for assistance (e.g., information on specific subject areas of the course material or the like), and may access old items relating to the course (e.g., old notes, old homework, old lecture slides, old examinations, etc.) that have been uploaded by others.

Similarly, the student may upload old useful information about the course for other students to share. A past student of the course may, for example, in turn upload old useful information (e.g., old notes, old homework, old lecture slides, old examinations, etc.), and may similarly rate the professor or teacher (or teaching assistant) or rate the old information attained from this system.

### BRIEF DESCRIPTION OF THE DRAWINGS

FIG. 1(a) is a flowchart of the on-line school old information retrieval system of this invention; and FIG. 1(b) is a continuation of the flowchart of the on-line school old information assistance system of this invention.

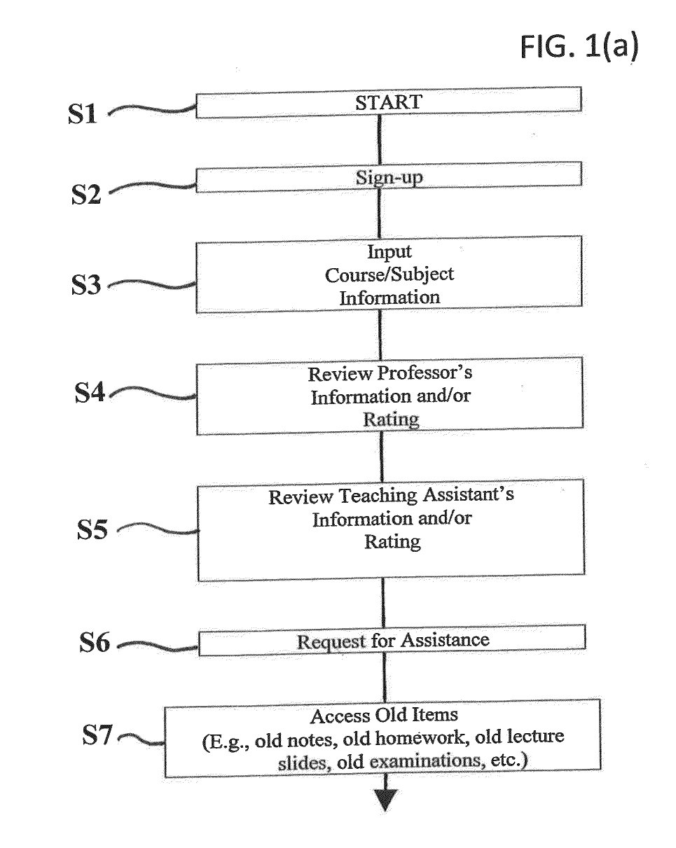

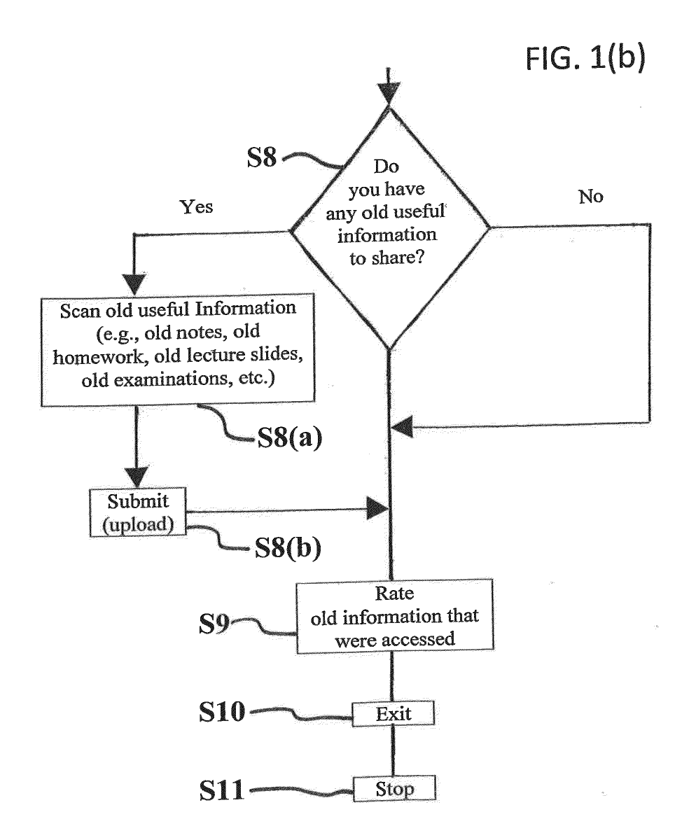

### DETAILED DESCRIPTION OF THE PREFERRED EMBODIMENTS

A student (or person interested in searching about a school or college course) gets in the internet (S1) and on-line, signs up (S2) into the system of this invention, The student inputs the course or subject information of interest. (including a course name or a number that corresponds to the course name (S3). The student, by inputting the course or subject information for the course of interest, can now access information pertaining to the course.

Once the student has access to the information related to the course, the student can access and review information pertaining to the teacher or professor who teaches the course within a given school or university (S4). For example, information regarding the teacher or professor based on information uploaded by previous students may now be accessed by a student, including any ratings on the teaching skills, test grading skills or other information pertaining to the teacher or professor.

Similar types of information may be accessed on a specific teaching assistant who teaches the course in step (S5). Further, the student may request additional assistance in step (S6) by, for example, posting or uploading a problem taught in the course for other students or persons to evaluate and provide feedback.

In step (S7), the student can also access old information, including old notes, old homework, old lecture slides, old examinations or the like that have been previously uploaded by past students. In step (S8), the student may similarly reciprocate if the student has useful information that the student may want to share in the system. If so, the student can scan the old information pertaining to the course (including old notes, old homework, old lecture slides, old examinations or the like) S8(a), and upload the information S8(b) into the system for others to share.

The student can also rate the old information S9 that was accessed from the system. When, for example, the student has completed the course, the student can in turn rate the course and its teacher or professor, and upload this information into the system for others to share.

When the course information from the system has been accessed to the student's satisfaction, the student may exit the system (S10) by logging off from the system (S11).

The present invention is not limited to the above-described embodiments; and various modifications in design, structural arrangement or the like may be made without departing from the scope or equivalents of the present invention.

I claim:

1. A system for retrieving school old information on-line via the internet, comprising the steps of:
getting into the internet;
signing-up to access into the system;
inputting course/subject information of interest; and
accessing and reviewing a professor's or teacher's information.

2. The system, according to claim 1, wherein the step of accessing and reviewing a professor's or teacher's information includes accessing and reviewing the rating of the professor or teacher.

3. The system, according to claim 1, further comprising the step of requesting for assistance on problems related to the course/subject of interest.

4. The system, according to claim 1, further comprising the step of accessing old items related to the course/subject of interest.

5. The system, according to claim 4, wherein the step of accessing of old course/subject items includes the step of accessing at least old notes, old homework, old lecture slides and old examinations.

6. The system, according to claim 1, further comprising the step of uploading old useful information related to the course/subject of interest.

7. The system, according to claim 6, wherein the step of uploading of old useful information related to the course/subject of interest includes the step of uploading at least old notes, old homework, old lecture slides and old examinations.

8. The system, according to claim 5, further comprising the step of rating the old course/subject items that were accessed.

9. The system, according to claim 1, further comprising the step of accessing and reviewing a teaching assistant's information.

10. The system, according to claim 1, further comprising the step of logging off from the system.
